(19) United States
(12) Patent Application Publication
(10) Pub. No.: US 2021/0354282 A1
(43) Pub. Date: Nov. 18, 2021

(54) Screwdriver Tool and Screwdriver Tool Assembly

(71) Applicants: Chia-Chen Lin, Fuxing Township (TW); Horng-Jen Lin, Fuxing Township (TW)

(72) Inventor: Horng-Jen Lin, Fuxing Township (TW)

(21) Appl. No.: 17/314,189

(22) Filed: May 7, 2021

(30) Foreign Application Priority Data
May 12, 2020 (TW) 109205771

(51) Int. Cl. B25G 1/08; B25B 15/02

(52) U.S. Cl. CPC B25G 1/085; B25B 15/02

(57) ABSTRACT

The present disclosure provides a screwdriver tool assembly including a screwdriver tool and plural screwdriver bits. The screwdriver tool includes a main body, a cover, a working member, and an anti-detachment unit. The main body has a shaft member and a first axial hole penetrating the shaft member. The cover is arranged at a rear end of the main body and has a second axial hole. The working member is arranged at a front end of the main body and has a third axial hole. The first, the second, and the third axial holes communicate each other. The anti-detachment unit is adapted for preventing the screwdriver bit from moving backward to leave the screwdriver tool. Thus, the screwdriver tool assembly is able to receive plural screwdriver bits to be easy to carry. In addition, the process of changing the screwdriver bits becomes simpler.

### FIELD OF THE INVENTION

The present disclosure relates to a screwdriver tool, more especially to a screwdriver tool which is able to receive a plurality of screwdriver bits.

### BACKGROUND OF THE INVENTION

A screwdriver tool bit is inserted into the front end of the screwdriver tool to rotate the bolts or others. A conventional screwdriver tool as shown in FIG. 1 of patent TW 1522211 has a shaft and a handle. The screwdriver bit is detachably inserted into the front end of the shaft and can be replaced by other screwdriver bits.

However, the screwdriver bits for replacing are usually received in a tool box for carrying. When replacing the screwdriver bit, the user has to remove the screwdriver bit from the screwdriver tool and place it into the tool box first. After removing the screwdriver bit, the user has to take another screwdriver bit out from the tool box and insert it into the front end of the screwdriver tool. Thus, it is inconvenient to replace the screwdriver bit.

The present invention is, therefore, arisen to obviate or at least mitigate the above mentioned disadvantages.

### SUMMARY OF THE INVENTION

One of the objects of the present invention is to provide a screwdriver tool which is able to receive screwdriver bits therein for carrying.

An other of the objects of the present invention is to provide a screwdriver tool whose rear end is able to receive the screwdriver bit removed from the front end of the screwdriver tool. At the same time, another screwdriver bit is pushed forward to be protruded from the front end of the screwdriver too so as to simplify the process of replacing the screwdriver bits.

To achieve the above and other objects, the screwdriver tool of the present invention adapted for receiving a plurality of screwdriver bits includes a main body, a cover, and a working member. The main body has a shaft member and a first axial hole. The first axial hole penetrates the shaft member along an axis. The cover is disposed on a rear end of the main body. The cover has a second axial hole. The working member is disposed on a front end of the main body. The working member has a third axial hole. The first axial hole, the second axial hole, and the third axial hole communicate each other.

In some embodiments, the shaft member has a sleeve member and an inner member. The inner member is received in the sleeve member.

In some embodiments, the screwdriver tool further has a supporting member and an anti-detachment member. The supporting member is movable with respect to the cover along the axis. The supporting member has a fourth axial hole. The first axial hole, the second axial hole, and the fourth axial hole communicate each other. The anti-detachment member is movably arranged on the supporting member. When the supporting member is located at a pressing position, the inner wall of the second axial hole abuts against the anti-detachment member so that the anti-detachment member tends to move toward the axis to be protruded into the fourth axial hole.

In some embodiments, the second axial hole of the cover has a first conical face. The first conical face expands toward the rear end of the main body. When the supporting member is located at the pressing position, the first conical face of the second axial hole abuts against the anti-detachment member.

In some embodiments, a second conical face is formed on the outer peripheral face of the supporting member. The second conical face expands toward the front end of the main body.

In some embodiments, the screwdriver tool further has an elastic member. An end of the elastic member abuts against the main body, and an other end of the elastic member abuts against the supporting member. The elastic member provides an elastic force to the supporting member so that the supporting member tends to return to the pressing position.

To achieve the above and other objects, the present invention further provides a screwdriver tool assembly. The screwdriver tool assembly includes the screwdriver tool mentioned above and a plurality of screwdriver bits. The screwdriver bits are received in the screwdriver tool and are aligned one by one along the axis.

Thereby, the screwdriver tool is able to receive a plurality of screwdriver bits. When changing the screwdriver bits, the user can remove the screwdriver bit at the front end of the screwdriver tool and place it into the first axial hole of the main body via the second axial hole of the cover for receiving.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

The present disclosure can be more fully understood by reading the following detailed description of the embodiment, with reference made to the accompanying drawings as follows:

FIG. 1 is a stereogram showing a first embodiment of a screwdriver tool assembly of the present invention;

FIG. 2 is a breakdown drawing showing a first embodiment of a screwdriver tool assembly of the present invention;

FIG. 3 is an illustration showing a first embodiment of a screwdriver tool assembly of the present invention when a supporting member is located at a pressing position;

FIG. 4 is a partial enlargement of FIG. 3;

FIG. 5 is an illustration showing a first embodiment of a screwdriver tool assembly of the present invention when a supporting member is located at a release position;

FIG. 6 is a partial enlargement of FIG. 5.

### DETAILED DESCRIPTION OF THE PREFERRED EMBODIMENTS

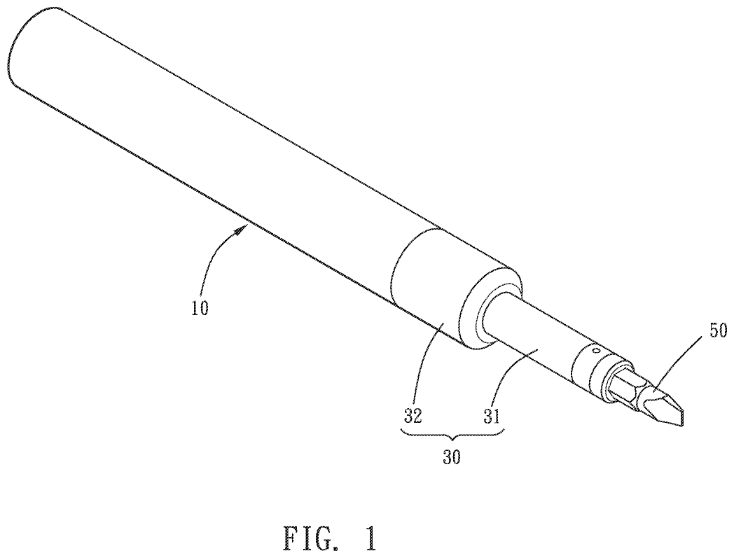

Please refer to FIG. 1 to FIG. 4, the screwdriver tool assembly of the present invention in the first embodiment includes a screwdriver tool and a plurality of screwdriver bits.

The screwdriver tool includes a main body 10, a cover 20, a working member 30, and an anti-detachment unit.

The main body 10 has a shaft member 11 and a first axial hole 12, as shown in FIG. 3. The first axial hole 12 penetrates the shaft member 11 along an axis to receive plural screwdriver bits. The shaft member 11 includes a sleeve member 111 and an inner member 112. The inner member 112 is detachably received in the sleeve member 111. The inner face of the inner member 112 is formed with a step to form an abutting face 1121.

The cover 20 is arranged at the rear end of the main body 10 and has a second axial hole 21. The second axial hole 21 also has a step to have a first conical face 211 and a stepped face 212. The first conical face 211 is hexagonal frustum-shaped and expands forward. The stepped face 212 is located at the rear end of the first conical face 211.

The working member 30 is located at the front end of the main body 10. In the present embodiment, the working member 30 is ratchet head to have an engaging member 31 and a direction-controlling member 32. The engaging member 31 has a third axial hole 311 and a restriction ball 312. The third axial hole 311 is adapted for receiving the screwdriver bit, and the restriction ball 312 is adapted for positioning the screwdriver bit 50 to prevent the screwdriver bit 50 from detaching forward. The direction controlling member 32 is used to change the driving direction of the screwdriver bit to make the screwdriver bit 50 rotate clockwise, counterclockwise, or not rotate. The detail structure of the ratchet head is common in the art and will not be discussed here. However, in other possible embodiments of the present invention, the working member can be a connecting member to grasp the screwdriver bit, which is unable to change the driving direction.

The anti-detachment unit includes a supporting member 41, two anti-detachment members 42, and an elastic member 43.

The supporting member 41 is received in the second axial hole 21 of the cover 20 and is movable with respect to the cover 20 along the axis. The supporting member 41 has a fourth axial hole 411. In the present embodiment, the fourth axial hole 411 is formed with a polygonal opening 4111 at the front end of the supporting member 41. In other possible embodiments, the opening can be other shapes. The first axial hole 11, the second axial hole 21, the third axial hole 311, and the fourth axial hole 411 communicate each other. A second conical face 412 is formed on the outer peripheral face of the supporting member 41. The second conical face 412 expands forward. Besides, at least one receiving groove 413 is recessedly formed on the outer peripheral face of the supporting member 41 and communicates the fourth axial hole 411. The at least one receiving groove 413 preferably includes two said receiving grooves 413 which are located at two sides of the supporting member 41.

The anti-detachment member 42 is rod-shaped and is arranged in the receiving groove 413 of the supporting member 41. The anti-detachment member 42 is movable with respect to the supporting member 41 toward the axis or away from the axis. Besides, the number of the receiving grooves 413 corresponds to the number of the anti-detachment members 42.

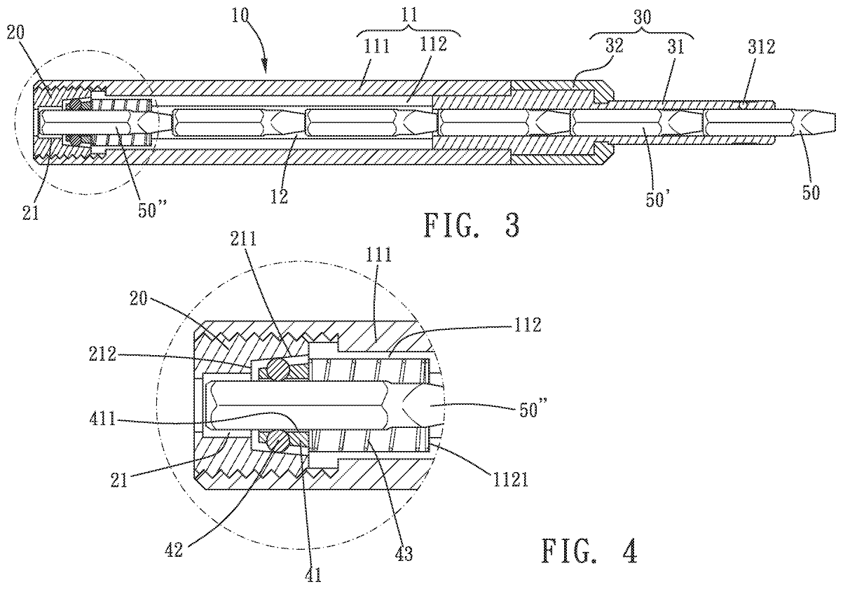

The elastic member 43 is a spring received in the inner member 112. An end of the elastic member 43 abuts against the abutting face 1121 of the inner member 112, and the other end of the elastic member 43 abuts against the front end of the supporting member 41. Thereby, the elastic member 43 provides an elastic force to the supporting member 41 so that the supporting member 41 tends to return to the pressing position, as shown in FIG. 4.

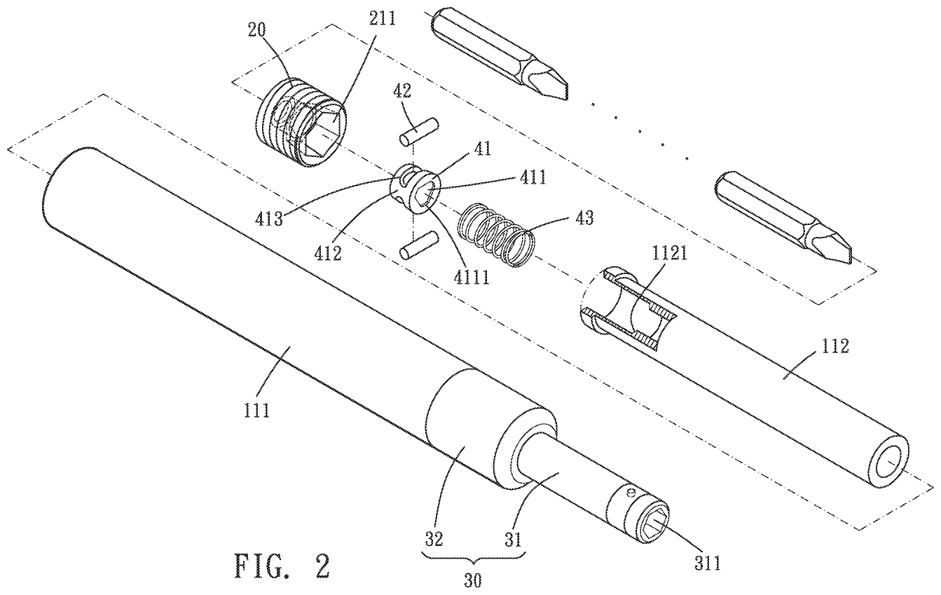

Please refer to FIG. 2 to FIG. 4 for the process of assembling the screwdriver tool assembly of the first embodiment of the present invention. The working member 30 is inserted into the front end of the sleeve member 111 of the main body 10, for example, by interference fit. The inner member 112 and the anti-detachment unit are further inserted into the sleeve member 111. And then, the cover 20 is installed onto the rear end of the sleeve member 111 of the main body 10, for example, by screwing. The screwdrivers bits are inserted into the screwdriver tool via the second axial hole 21 of the cover 20. It is noted that the stepped face 212 of the cover 20 can be abutted against by the supporting member 41 in order to prevent the supporting member 41 from leaving the cover 20 backward. In other possible embodiments, the engagement between the working member 30 and the main body and between the cover 20 and the main body can be made by screwing, interference fit, gluing, or other fixing members.

FIG. 3 and FIG. 4 show the assembled structure. The working member 30 positions the screwdriver bit 50, and the screwdriver bit 50 is protruded from the front end of the working member 30 for rotating bolts or other fixing members. At this time, the supporting member 41 is located at the pressing position, so the anti-detachment member 42 pushes the screwdriver bit 50″ to prevent the screwdriver bit 50″ from moving backward to leave the screwdriver tool.

When the supporting member 41 is located at the pressing position, the first conical face 211 of the second axial hole 21 abuts against the anti-detachment member 42 so that the anti-detachment member 42 is protruded into the fourth axial hole 411 of the supporting member 41 toward the axis. Thereby, the screwdriver bit 50″ is fastened by the two anti-detachment members 42 from two sides.

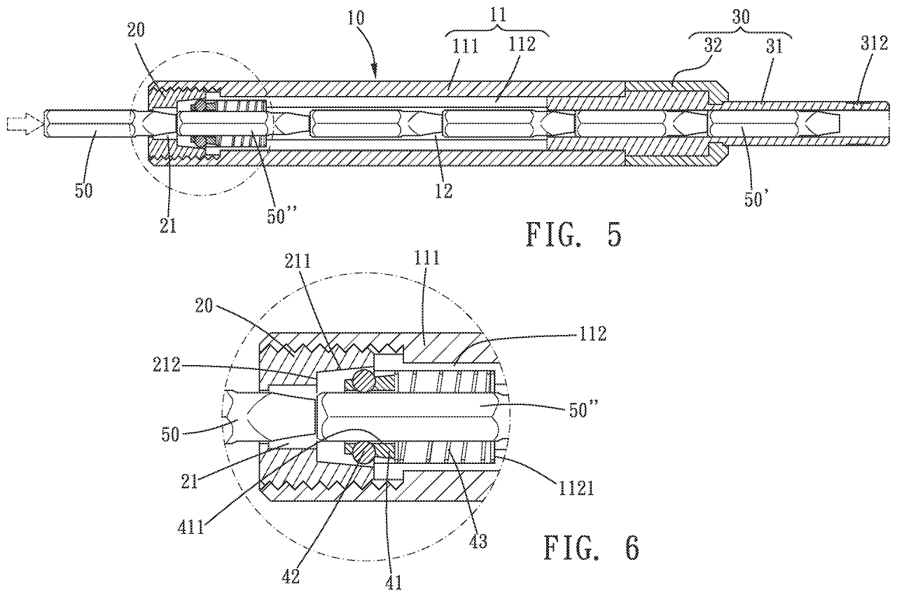

Please refer to FIG. 3 to FIG. 6, to change the screwdriver bit, the user can remove the screwdriver bit 50 at the front end of the screwdriver tool and insert it into the screwdriver tool via the second axial hole 21 of the cover 20. When inserting the screwdriver bit 50, other screwdriver bits are pushed forward to drive the supporting member 41 to move toward the release position as shown in FIG. 5 and FIG. 6, allowing the anti-detachment members 42 to release the screwdriver bit 50″.

Specifically, the first conical face 211 of the second axial hole 21 of the cover 20 expands forward, so the anti-detachment member 42 can move away from the axis with respect to the supporting member 41 when the supporting member 41 moves toward the release position. In other words, the anti-detachment member 42 can move toward the first conical face 211 to release the screwdriver bit 50″. In addition, the screwdriver bit 50″ is not fastened by the anti-detachment member 42, so the screwdriver bit 50″ can be pushed forward with respect to the supporting member 41 and the anti-detachment member 42 by the screwdriver bit 50.

When the screwdriver bit 50 is inserted, the elastic member 43 pushes the supporting member 41 to make it return to the pressing position as shown in FIG. 4, and the anti-detachment member 42 is moved toward the axis with respect to the supporting member 41 to grasp the screwdriver bit 50 in order to prevent the screwdriver bit 50 from moving backward to leave the screwdriver tool. Besides, at the same time, the screwdriver bit 50″ is protruded from the front end of the working member 30, so the process of changing the screwdriver bit is completed.

It is noted that the inner member of the main body can be replaced by ones in different inner diameter because the inner member 112 is detachably received in the sleeve member 111. Thus, the appropriate inner member is selected depending on the outer diameter of the screwdriver bit so as to suitably receive the screwdriver bit to prevent the inner member having the too small inner diameter from failing to receive the screwdriver bit and to prevent the screwdriver bit from shaking in the inner member having the too large inner diameter. Also, it reduces cost because other components of the screwdriver tool don't have to be replaced when used on screwdriver bits in different sizes.

In the present embodiment, the screwdriver tool is adapted for receiving the flathead screwdriver bits. However, in other possible embodiments, the screwdriver tool can be used to receive various types of screwdriver bits, such as Phillips screwdriver bits, Torx screwdriver bits, or hexagonal screwdriver bits, to accommodate the different types of bolts.

In the present embodiment, a portion of the inner peripheral face of the inner member located at a front side of the abutting face, or in other words, a portion of the inner peripheral face of the inner member not corresponding to the elastic member, is cylinder-shaped, as shown in FIG. 2 and FIG. 3. In other possible embodiments, the portion of the inner peripheral face of the inner member can be hexagonal to guide the screwdriver bit so that the screwdriver bit may not rotate about the axis in the inner member.

In the present embodiment, the shaft member of the main body has the inner member detachably received in the sleeve member, and the inner peripheral face of the inner member is step-shaped to form the abutting face. In other possible embodiments, the inner member and the sleeve member can be integrally formed to be a single piece, or the inner member can be ignored so that the screwdriver bit is received in the sleeve member. Alternatively, the abutting face can be formed on the inner peripheral face of the sleeve member so that the elastic member abuts against the sleeve member.

In the present embodiment, the screwdriver tool has two said anti-detachment members to grasp the screwdriver bit from two sides of the screwdriver bit. In other possible embodiments, the screwdriver tool can have only one anti-detachment member or more than 3 anti-detachment members. If the first conical face of the second axial hole of the cover is able to abut against the anti-detachment member to make the anti-detachment member protrude in the fourth axial hole of the supporting member toward the axis, the screwdriver bit can be fastened as the present embodiment.

In the present embodiment, the second axial hole of the cover is step-shaped to have the first conical face and the stepped face. In other possible embodiments, the second axial hole of the cover can have no stepped face, and the first conical face extends to the rear end of the second axial hole so that the supporting member abuts against the first conical face backward to prevent the supporting member from moving backward to leave the cover.

In the present embodiment, the first conical face of the cover is hexagonal frustum-shaped. In other possible embodiments, the first conical face can be cone frustum-shaped. If the first conical face of the cover is able to abut against the anti-detachment member when the supporting member is at the pressing position, the anti-detachment member is protruded into the fourth axial hole of the supporting member toward the axis as the present embodiment.

In the present embodiment, the outer peripheral face of the supporting member has a second conical face expanding forward. In other possible embodiments, the outer peripheral face of the supporting member can be cylinder-shaped. That is, two ends of the supporting member have the same diameter. If the first conical face of the cover is able to abut against the anti-detachment member when the supporting member is at the pressing position, the anti-detachment member is protruded into the fourth axial hole of the supporting member toward the axis as the present embodiment.

In conclusion, the screwdriver tool assembly of the present invention is able to receive plural screwdriver bits therein. Besides, the screwdriver tool has the first axial hole, the second axial hole, and the third axial hole communicating each other, so the screwdriver bit removed from the front end of the screwdriver tool can be inserted into the screwdriver tool via the second axial hole and pushes other screwdriver bits forward. Thereby, the first one of the screwdriver bits is protruded for working. Therefore, the process of changing the screwdriver bit is simplified. In addition, the anti-detachment unit can grasp the screwdriver bit to prevent it from moving backward to leave the screwdriver tool.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A screwdriver tool, adapted for receiving a plurality of screwdriver bits, the screwdriver tool including:
a main body, the main body having a shaft member and a first axial hole, the first axial hole penetrating the shaft member along an axis;
a cover, disposed on a rear end of the main body, the cover having a second axial hole;
a working member, disposed on a front end of the main body, the working member having a third axial hole;
wherein the first axial hole, the second axial hole, and the third axial hole communicate each other.

2. The screwdriver tool of claim 1, further having an anti-detachment member, an inner wall of the second axial hole abutting against the anti-detachment member so that the anti-detachment member tends to move toward the axis.

3. The screwdriver tool of claim 1, further having a supporting member, the supporting member being movable with respect to the cover along the axis, the supporting member having a fourth axial hole, the first axial hole, the second axial hole, and the fourth axial hole communicating each other.

4. The screwdriver tool of claim 2, further having a supporting member, the supporting member being movable with respect to the cover along the axis, the supporting member having a fourth axial hole, the first axial hole, the second axial hole, and the fourth axial hole communicating each other, the anti-detachment member being movably arranged on the supporting member, an inner wall of the second axial hole abutting against the anti-detachment member when the supporting member is located at a pressing position so that the anti-detachment member is protruded into the fourth axial hole toward the axis.

5. The screwdriver tool of claim 1, further having an elastic member, an end of the elastic member abutting against the main body.

6. The screwdriver tool of claim 2, further having an elastic member, an end of the elastic member abutting against the main body.

7. The screwdriver tool of claim 3, further having an elastic member, an end of the elastic member abutting against the main body, an other end of the elastic member abutting against the supporting member.

8. The screwdriver tool of claim 4, further having an elastic member, the elastic member providing an elastic force to the supporting member so that the supporting member tends to return to the pressing position.

9. The screwdriver tool of claim 1, wherein a first conical face is formed on the second axial hole of the cover, the first conical face expands toward the front end of the main body.

10. The screwdriver tool of claim 4, wherein a first conical face is formed on the second axial hole of the cover, the first conical face expands toward the front end of the main body, the first conical face abuts against the anti-detachment member when the supporting member is located at the pressing position.

11. The screwdriver tool of claim 3, wherein a second conical face is formed on an outer peripheral face of the supporting member, the second conical face expands toward the front end of the main body.

12. The screwdriver tool of claim 4, wherein a second conical face is formed on an outer peripheral face of the supporting member, the second conical face expands toward the front end of the main body.

13. The screwdriver tool of claim 1, wherein the shaft member having a sleeve member and an inner member, the inner member is received in the sleeve member.

14. A screwdriver tool assembly, including:
the screwdriver tool of claim 1;
a plurality of screwdriver bits, the screwdriver bits being received in the screwdriver tool and being aligned one by one along the axis.
